(19) United States
(12) Patent Application Publication
(10) Pub. No.: US 2025/0293557 A1
(43) Pub. Date: Sep. 18, 2025

(54) MOTOR WITH A COOLING STRUCTURE

(71) Applicants: HYUNDAI MOTOR COMPANY, Seoul (KR); KIA CORPORATION, Seoul (KR)

(72) Inventors: Jae-Hyeok Song, Hwaseong-si (KR); Young-Chul Kim, Hwaseong-si (KR)

(73) Assignees: HYUNDAI MOTOR COMPANY, Seoul (KR); KIA CORPORATION, Seoul (KR)

(21) Appl. No.: 18/786,000

(22) Filed: Jul. 26, 2024

(30) Foreign Application Priority Data
Mar. 15, 2024 (KR) 10-2024-0036499

(51) Int. Cl. H02K 1/20

(52) U.S. Cl. CPC H02K 1/20; H02K 2213/03

(57) ABSTRACT

A motor has a cooling structure and includes a housing, a stator provided inside the housing, a rotor provided inside the stator, and a shaft that passes through the rotor. A core through-hole passes through an outer surface and an inner surface of the stator and is formed in the stator so that oil supplied through the core through-holes from the outside of the stator is supplied to an air gap formed between the inner surface of the stator and the rotor. Cooling efficiency of the motor can thus be improved by directly cooling a core and a center of a coil.

### CROSS-REFERENCE(S) TO RELATED APPLICATIONS

This application claims priority to Korean Patent Application No. 10-2024-0036499, filed on Mar. 15, 2024, which is incorporated herein by reference in its entirety.

### BACKGROUND OF THE PRESENT DISCLOSURE

### Technical Field

Embodiments of the present disclosure relate to a motor that can cool parts more efficiently using cooling oil.

### Description of Related Art

A motor is provided with a shaft, a rotor, and a stator in a housing. In an eco-friendly vehicle, the motor is used to generate a driving force for driving.

When a motor is driven, a high temperature is generated in a coil and the like, so cooling of major components such as the coil and the like is essential. This is directly related to efficiency of the motor and protection of core components.

To this end, motors with various cooling structures are being developed. For example, Korean Patent Laid-Open Application No. 10-2022-0082593, discloses a structure that cools the inside and outside of an end coil using a cooling pipe. This structure has a limitation in that it cannot directly cool a center of a core (coil), which has the highest temperature in a stator.

The contents described in the above Description of Related Art are to aid in understanding the background of the present disclosure and may include what is not previously known to those of ordinary skill in the art to which the present disclosure pertains.

### SUMMARY OF THE PRESENT DISCLOSURE

An embodiment of the present disclosure is directed to providing a motor with a cooling structure that can improve cooling efficiency of the motor by directly cooling a core and a coil center.

Other objects and advantages of the present disclosure can be understood by the following description and should become apparent with reference to the embodiments of the present disclosure. Also, it should be apparent to those of ordinary skill in the art to which the present disclosure pertains that the objects and advantages of the present disclosure can be realized by the motor as claimed and by combinations thereof.

In accordance with an embodiment of the present disclosure, a motor with a cooling structure is provided. The motor includes a housing, a stator provided inside the housing, a rotor provided inside the stator, and a shaft, which passes through the rotor. A plurality of core through-holes, which pass through an outer surface and an inner surface of the stator, are formed in the stator. Thus, oil, which is supplied via the core through-holes from the outside of the stator, is supplied to an air gap formed between the inner surface of the stator and the rotor.

In addition, the core through-hole may include a first core through-hole formed from the outer surface of the stator to an inside of the stator and may include a second core through-hole formed from the inner surface of the stator to the inside of the stator. The first core through-hole and the second core through-hole may communicate inside the stator.

Furthermore, assuming that a 12 o'clock direction in a cross section of the stator is 0°, the core through-hole may be formed at a position in the range of ±30° based on the 12 o'clock direction.

In addition, the core through-hole may be formed at a position in the range of 180°±30° based on the 12 o'clock direction.

In addition, assuming that the 12 o'clock direction in the cross section of the stator is 0°, the core through-hole may be formed at a position in the range of +90°±30° and −90°±30°.

In particular, the stator may be formed by stacking a plurality of electrical steel sheets. Among the plurality of electrical steel sheets, an electrical steel sheet in which the first core through-hole is formed and an electrical steel sheet in which the second core through-hole is formed may be stacked.

A stator channel may be formed on the outer surface of the stator in a longitudinal direction of the stator. The first core through-hole may communicate with the stator channel.

In addition, holes for oil discharge and internal pressure adjustment may be formed at both ends of the stator channel.

In addition, the stator channel may be formed as a plurality of stator channels at regular intervals in a circumferential direction of the stator.

In addition, a plurality of passages may be formed in each stator channel.

In addition, a cooling fin may be formed in each stator channel.

### BRIEF DESCRIPTION OF THE DRAWINGS

FIG. 1 is a diagram illustrating a side cross-section view of a motor of the present disclosure.

FIGS. 2 and 3 are diagrams illustrating transverse cross-section views of a stator of a motor of the present disclosure.

FIG. 4 is an enlarged view illustrating a portion of the stator of FIG. 3.

FIG. 5 is a diagram illustrating an outer surface of a stator of the present disclosure.

FIG. 6 is a diagram illustrating a transverse cross-section view of an end portion of the stator of FIG. 5.

FIG. 7 is a diagram illustrating a portion of a motor of the present disclosure.

FIG. 8 is a diagram illustrating a side cross-section view of a cooling structure of the present disclosure.

FIG. 9 is a diagram illustrating a perspective view of the cooling structure of FIG. 8.

### DESCRIPTION OF SPECIFIC EMBODIMENTS

In order to fully understand the present disclosure, operational advantages of the present disclosure, and objects attained by practicing the present disclosure, reference should be made to the accompanying drawings that illustrate embodiments of the present disclosure and to the description of the accompanying drawings provided below.

In describing embodiments of the present disclosure, descriptions of known technologies or repeated descriptions may have been reduced or omitted to avoid unnecessarily obscuring the gist of the present disclosure. When a component, device, element, or the like of the present disclosure is described as having a purpose or performing an operation, function, or the like, the component, device, or element should be considered herein as being “configured to” meet that purpose or perform that operation or function.

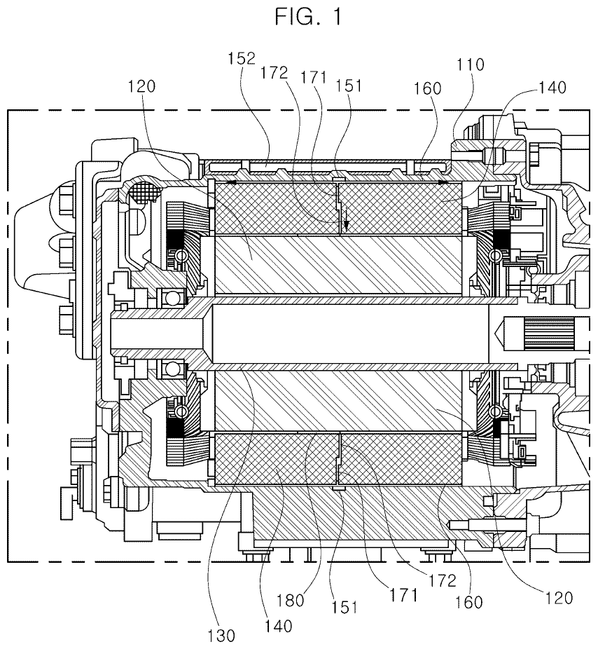

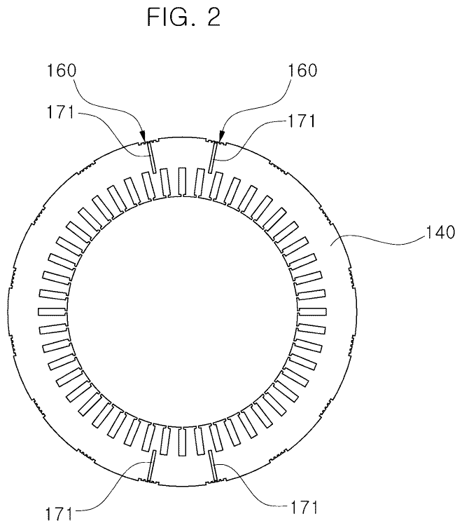

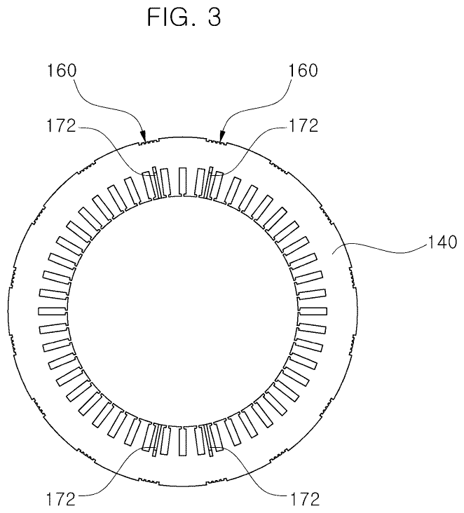

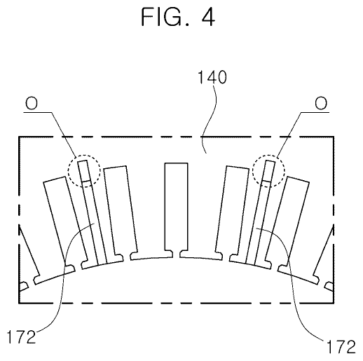

FIG. 1 is a diagram illustrating a side cross-section of a motor of the present disclosure. In addition, FIGS. 2 and 3 are diagrams illustrating transverse cross-sections of a stator of the motor of the present disclosure. FIG. 4 is an enlarged view illustrating a portion of FIG. 3.

Hereinafter, a motor with a cooling structure according to one embodiment of the present disclosure is described with reference to FIGS. 1-4.

The motor of the present disclosure includes a rotor 120, a shaft 130, and a stator 140 in a housing 110. The rotor 120 rotates by an applied current to rotate the shaft 130 passing through the rotor 120.

As shown in the drawings, the stator 140 is provided in the form of surrounding the rotor 120 on an outer side of the rotor 120. An air gap 180 is formed between the rotor 120 and the stator 140.

Parts in the motor are cooled by a cooling structure in which cooling oil is supplied by an electric oil pump (EOP) to cool the motor. The oil cooled through an oil cooler is supplied into the motor.

To this end, a housing passage 151 is formed in the housing 110 in a circumferential direction of the housing 110 with a cylindrical shape. The oil supplied from the EOP is supplied to the housing passage 151 in the housing 110 through a housing external passage 152 formed outside the housing 110.

In addition, a stator channel 160 is formed on an outer surface of the stator 140 to communicate with the housing passage 151 in a longitudinal direction of the stator 140.

The housing passage 151 and the stator channel 160 are described in more detail below.

In addition, according to the present disclosure, in order to directly cool a core and a coil center, a core through-hole is formed in the stator 140 to communicate with the stator channel 160 and pass through an inner surface of the stator 140. Thus, the oil from the housing passage 151 passes through the stator channel 160 to be supplied through the core through-hole. The stator 140 is thus cooled and the oil is supplied to the air gap between the stator 140 and the rotor 120.

In this way, according to the present disclosure, compared to the existing method of cooling only the end coil, cooling efficiency can be more improved using a structure that can directly cool the coil center, which is a portion of the highest temperature. This is done by cooling the core and the coil center through the stator channel 160 and the core through-hole.

Furthermore, referring to FIGS. 2-4, the core through-hole may be divided into a first core through-hole 171 formed inward from the outer surface of the stator 140 and a second core through-hole 172 formed inward from the inner surface of the stator 140.

The first core through-hole 171 and the second core through-hole 172 may communicate inside the stator 140 and may be formed to not be parallel to each other.

FIG. 2 shows a transverse cross section of a portion where the first core through-hole 171 is formed. FIG. 3 shows a transverse cross section of a portion where the second core through-hole 172 is formed.

A structure may be formed such that side surfaces of inner ends of the first core through-hole 171 and the second core through-hole 172 are in contact with each other. Alternatively, as shown in FIG. 4, an overlapping hole O connecting the inner ends of the first core through-hole 171 and the second core through-hole 172 may be formed. Thus, the first core through-hole 171 and the second core through-hole 172 may communicate with each other.

Due to a stepped hole shape of the core through-hole, it is possible to smoothly discharge the oil from the stator channel 160 and minimize performance degradation of the core.

Furthermore, the core through-hole may be provided as a plurality of core through-holes. At least one core through-hole is included in an upper body in the cross section of the stator 140, as shown in the drawings, and at least one core through-hole may be additionally included in a lower body. In addition, assuming that a 12 o'clock direction in the cross section of the stator 140 is 0°, the core through-hole of the upper body is formed as a plurality of core through-holes at positions in the range of ±15°, and in one example ±30°, based on the 12 o'clock direction on the cross section.

The oil is supplied from the housing passage 151 to the 12 o'clock direction. Thus, a flow rate of cooling oil flowing into the stator channel 160 in the 12 o'clock direction becomes highest. Thus, it is advantageous for the core through-hole of the upper body to be positioned as described above. Similarly, it is advantageous that a plurality of core through-holes of the lower body are formed at positions in the range of 180°±30°, and in one example 180°±15°, based on the 12 o'clock direction in the cross section. Due to the structure, since the oil supplied in a 6 o'clock direction through an internal channel of the housing is relatively small, the through-hole in the 6 o'clock direction may be used as an oil discharge channel. Also, in this case, it may be advantageous for cooling through the stator channel in the 6 o'clock direction.

In addition, when an inside of the motor is filled with the oil, some portions of the core in the 6 o'clock direction may be submerged in the oil. Thus, the role of the through-hole in the 6 o'clock direction may be changed depending on an amount of the oil.

For example, when the stator channel in the 6 o'clock direction is submerged the oil, the through-hole may be utilized to supply the oil to the air gap rather than discharging oil. Since it is advantageous for cooling performance as an oil flow is smooth in the through-hole, this is also advantageous from a cooling performance perspective.

In other words, in the through-hole in the 6 o'clock direction, a direction in which the oil flows is determined by a pressure difference between an amount of the oil in the air gap and an amount of the oil in the stator channel.

Meanwhile, according to the purpose and environment of implementation, core through-holes may be added in 3 o'clock and 9 o'clock directions, i.e., at 90-degree intervals in the cross section of the stator 140.

Thus, the core through-hole formed in the upper body and the core through-hole formed in the lower body may be symmetrical to each other based on a central axis of the stator 140.

Through the arrangement of the core through-holes, cooling efficiency can be further improved by maximizing a passing flow rate.

Meanwhile, the stator 140 may be formed by stacking a plurality of electrical steel sheets. In this case, in order to form the core through-hole, the core through-hole may be formed by stacking an electrical steel sheet in which the first core through-hole 171 is formed and an electrical steel sheet in which the second core through-hole 172 is formed among the plurality of electrical steel sheets.

According to the present disclosure, the performance degradation of the core is minimized while smoothly discharging the oil from the stator channel 160 through the stepped hole shape of the core through-hole. When the core through-hole is formed in a straight line shape, a portion of the electrical steel sheet is open, resulting in a disadvantageous shape for stacking the electrical steel sheets by accurately matching the sizes and positions of the through-holes. That is to say, the electrical steel sheet may shrink based on an open region.

Therefore, in order to form a specific passage inside the stacked core, like the configuration of the core through-hole of the present disclosure, it is also more suitable for manufacturing the specific passage by forming a supply part from the outside to the inside, a discharge part from the inside to a direction for cooling again, and a connection part connecting the supply part and the discharge part.

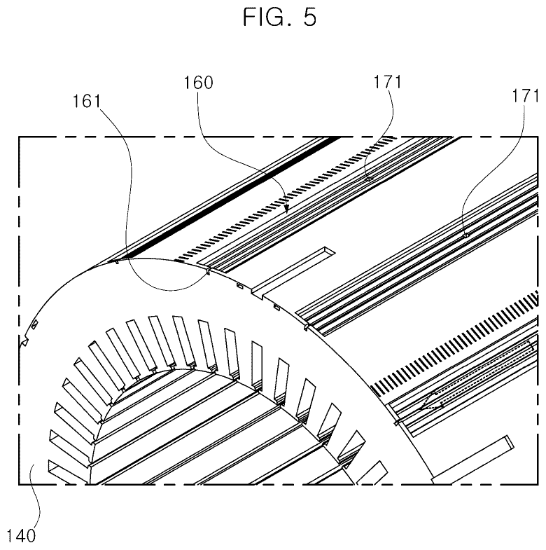

Next, FIG. 5 is a diagram illustrating an outer surface of the stator of the present disclosure.

The stator channel 160 is formed on the outer surface of the stator 140 to communicate with the housing passage 151 in the longitudinal direction of the stator 140.

The oil is supplied into three equal parts to outlets of stator channel 160 and the core through-hole, a structure that minimizes drag is formed, and the core of the stator and a coil in a slot may be cooled by the stator channel 160.

Furthermore, the stator channel 160 may be formed as a plurality of stator channels 160 at regular intervals in the circumferential direction. One stator channel 160 may include a plurality of passages.

In addition, in order to increase a contact area between the stator channel 160 and the oil, a cooling fin in a concave-convex shape may be formed in the stator channel 160. The cooling fin may be formed as a plurality of cooling fins.

Here, it is important to form an oil pressure in the stator channel 160 so as to smoothly discharge the oil to the core through-hole. In order to form the oil pressure, end portions of some of the passages in the stator channel 160 may be spaced apart from end portions in the longitudinal direction of the stator 140 so that a partially closed structure may be formed.

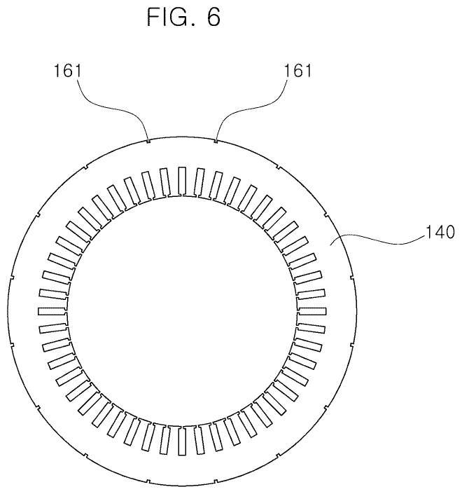

In addition, the end portions 161 of some of the passages in the stator channel 160 may be formed to extend to the end portions in the longitudinal direction of the stator 140. This forms a hole for oil discharge and internal pressure adjustment. A cross section of the end portion in the longitudinal direction of the stator 140 is shown in FIG. 6.

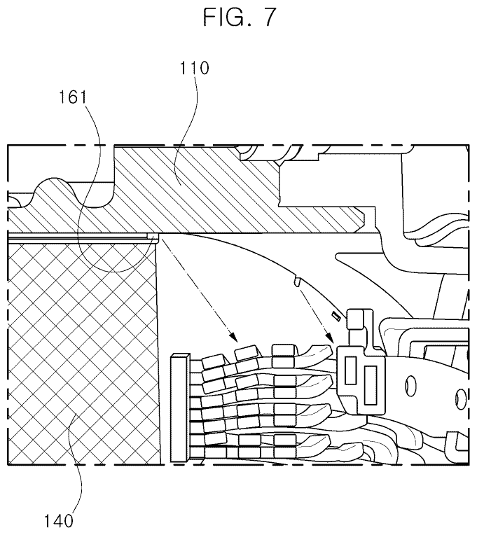

In this way, as shown in FIG. 7, the oil discharged through the end portions 161 of the stator channel 160, which is formed on the upper or lower surface of the stator 140, falls on an outer diameter of the coil to be used for secondary cooling.

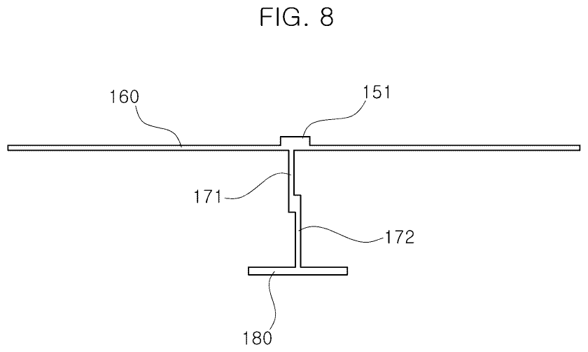

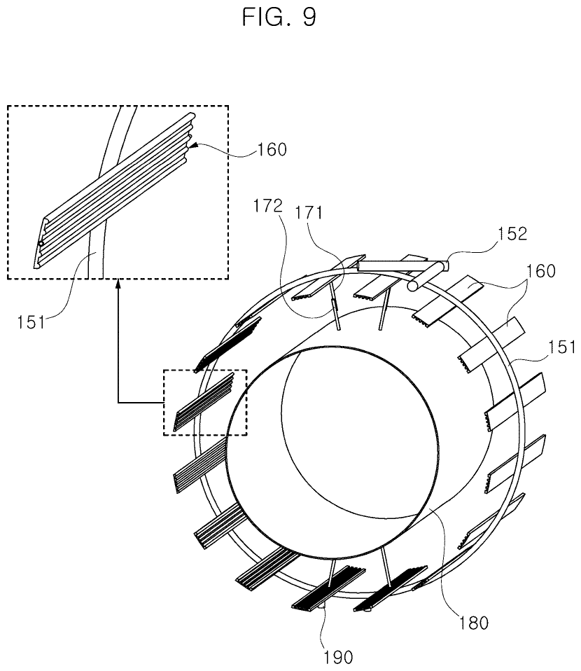

FIG. 8 is a diagram illustrating a side cross-section of the cooling structure of the present disclosure. FIG. 9 is a diagram illustrating a perspective view of the cooling structure.

The oil flowing into the stator channel 160 is divided into three equal parts and supplied to both ends of the core through-hole and the stator channel 160. It can be seen that it is a structure for maximally utilizing cooling effects of the stator channel 160 and the core through-hole.

When an amount of the oil discharged to the core through-hole is excessive, it may cause drag during motor rotation. Thus, it is important to develop a structure that can discharge an amount of the oil for increasing the cooling effect and minimizing the drag.

As shown in FIG. 9, a structure for discharging the oil through the core through-hole in the 6 o'clock direction (the oil is partially discharged to both ends of the air gap) and for compensating for oil loss due to a drain hole 190 for oil circulation is achieved.

According to the present disclosure, a coil center, which is a portion of the highest temperature in a driving motor, is cooled. Also, oil is effectively supplied into an air gap between a stator and a rotor through a stator cooling channel and a passing-through structure so that the coil center can be directly cooled.

Therefore, efficiency of the motor can be improved and parts can be protected.

According to the present disclosure, since the cooling structure described above can be achieved, there is an advantageous characteristic in terms of cost reduction and torque reduction. This is achieved by omitting cooling plate parts by intactly maintaining a cooling effect of the center of the stator while an amount of a supplied oil is independent of a rotation speed.

While embodiments of the present disclosure have been described with reference to the accompanying drawings, it should be apparent to those of ordinary skill in the art that various changes and modifications can be made without departing from the spirit and scope of the present disclosure without being limited to the embodiments disclosed herein. Accordingly, it should be noted that such alternations or modifications fall within the claims of the present disclosure, and that the scope of the present disclosure should be construed on the basis of the appended claims.

What is claimed is:

1. A motor with a cooling structure, the motor comprising:
a housing;
a stator disposed inside the housing;
a rotor disposed inside the stator; and
a shaft passing through the rotor,
wherein a plurality of core through-holes, which pass through an outer surface and an inner surface of the stator, are formed in the stator so that oil supplied through the core through-holes from the outside of the stator is supplied to an air gap formed between the inner surface of the stator and the rotor.

2. The motor of claim 1, wherein the core through-hole includes:
a first core through-hole formed from the outer surface of the stator to an inside of the stator; and
a second core through-hole formed from the inner surface of the stator to the inside of the stator,
wherein the first core through-hole and the second core through-hole communicate inside the stator.

3. The motor of claim 2, wherein, where a 12 o'clock direction in a cross section of the stator is equated to 0°, the core through-hole is formed at a position in a range of ±30° based on the 12 o'clock direction.

4. The motor of claim 2, wherein, where a 12 o'clock direction in a cross section of the stator is equated to 0°, the core through-hole is formed at a position in a range of 180°±30° based on the 12 o'clock direction.

5. The motor of claim 2, wherein, where a 12 o'clock direction in a cross section of the stator is equated to 0°, the core through-hole is formed at a position in a range of ±90°±30° and −90°±30°.

6. The motor of claim 2, wherein:
the stator is formed by stacking a plurality of electrical steel sheets; and
among the plurality of electrical steel sheets, an electrical steel sheet in which the first core through-hole is formed and an electrical steel sheet in which the second core through-hole is formed are stacked.

7. The motor of claim 2, wherein a stator channel is formed on the outer surface of the stator in a longitudinal direction of the stator, and wherein the first core through-hole communicates with the stator channel.

8. The motor of claim 7, wherein holes for oil discharge and internal pressure adjustment are formed at both ends of the stator channel.

9. The motor of claim 7, wherein the stator channel is formed as a plurality of stator channels at regular intervals in a circumferential direction of the stator.

10. The motor of claim 7, wherein a plurality of passages are formed in each stator channel.

11. The motor of claim 7, wherein a cooling fin is formed in each stator channel.
